(19) United States
(12) Patent Application Publication
(10) Pub. No.: US 2003/0121300 A1
(43) Pub. Date: Jul. 3, 2003

(54) Lock bolt alignment adjusting structure of a cylindrical type lock

(75) Inventor: Jo-Chiao Wang, Kaohsiung Hsien (TW)

Correspondence Address: Bacon & Thomas, 4th Floor, 625 Slaters Lane, Alexandria, VA, 22314, US

(73) Assignee: Taiwan Fu Hsing Industrial Co., Ltd., Kaohsiung Hsien (TW)

(21) Appl. No.: 10/029,295

(22) Filed: Dec. 28, 2001

(51) Int. Cl. E05B 13/10

(52) U.S. Cl. 70/224

(57) ABSTRACT

A lock bolt alignment adjusting structure of a cylindrical type lock includes a lock body, an outer rotation shaft, an inner rotation shaft, a driven member, and an adjusting ring. The lock body has two ends for passage and insertion of the outer rotation shaft and the inner rotation shaft, to drive the driven member mounted in the lock body. The driven member is externally connected with a lock bolt. The adjusting ring is mounted individually, and has an inner thread, a flange, and multiple teeth. The inner thread is screwed on the outer thread of a tube extended from the lock body. Thus, the teeth of the flange may be rotated to adjust a relative axial position between the adjusting ring and the lock bolt, so as to align with a lock bolt hole of a door plate.

### BACKGROUND OF THE INVENTION

1. Field of the Invention

The present invention relates to a lock bolt alignment adjusting structure of a cylindrical type lock, and more particularly to a lock bolt alignment adjusting structure of a cylindrical type lock, wherein the adjusting ring is mounted individually, so as to conveniently and quickly adjust a relative axial position between the adjusting ring and the lock bolt, so as to align with the axial position of a lock bolt hole of a door plate.

2. Description of the Related Art

A first conventional lock bolt alignment adjusting structure of a cylindrical type lock in accordance with the prior art shown in FIG. 1 is disclosed in U.S. Pat. No. 5,265,924, entitled “Lever Assembly for a Door Lock”. As shown in FIG. 1, the first conventional lock bolt alignment adjusting structure of a cylindrical type lock in accordance with the prior art comprises a lock body 910, an outer rotation shaft 911, an inner rotation shaft 912, an outer mounting disk 921, an adjusting ring 922, an outer cover plate 923, an outer decorative plate 924, an outer handle 925, an inner mounting disk 931, an inner cover plate 932, an inner decorative plate 933, and an inner handle 934. The lock body 910 has a cylindrical shape, and has two ends for passage and insertion of the outer rotation shaft 911 and the inner rotation shaft 912. The lock body 910 is form with an elongated slot aligned with the lock bolt hole of the door plate so that a driven member 913 may protrude outward therefrom. The driven member 913 has a locking port hooked on a lock bolt 914. The adjusting ring 922 has an inner thread screwed on an outer thread of one end of the lock body 910, so as to adjust the axial position of the driven member 913 and the lock bolt 914 relative to the lock bolt hole of the door plate. Thus, the cylindrical type lock is available for the door plates of different thickness or the lock bolt holes having different relative axial positions. The adjusting ring 922 has two locking recesses 926 to lock two combination posts 927 of the outer cover plate 923, thereby providing a positioning effect. However, when the user wishes to move the adjusting ring 922 to adjust the relative axial position between the lock bolt 914 and the lock bolt hole of the door plate, he needs to detach all of the parts outside of the outer mounting disk 921. Usually, the parts outside of the outer mounting disk 921 are many and more complicated. Thus, when the lock bolt 914 is not aligned with the lock bolt hole of the door plate due to the thickness of the door plate, the user has to in turn detach the outer handle 925, the outer decorative plate 924 and the outer cover plate 923, so as to adjust the adjusting ring 922. The outer handle 925 is provided with a lock core, so that the outer handle 925 cannot be assembled and dismantled easily, thereby causing inconvenience to the user, and thereby easily wearing the cylindrical type lock during detachment.

A second conventional lock bolt alignment adjusting structure of a cylindrical type lock in accordance with the prior art shown in FIG. 2 comprises a lock body 810, an outer rotation shaft 811, an inner rotation shaft 812, an outer mounting disk 821, an outer cover plate 822, an outer decorative plate 823, an outer handle 824, an inner mounting disk 831, an inner cover plate 832, an inner decorative plate 833, and an inner handle 834. The adjusting ring 825 of the conventional cylindrical type lock is directly combined with the outer mounting disk 821 integrally. The adjusting ring 825 has an inner thread screwed on an outer thread of one end of the outer rotation shaft 811, to drive a driven member (not shown), so as to adjust the axial position of the driven member relative to the lock bolt hole (not shown) of the door plate. Thus, the cylindrical type lock is available for the door plates of different thickness or the lock bolt holes having different relative axial positions, so as to drive and adjust the axial position of a lock bolt (not shown) that is connected with the driven member. However, the outer cover plate 822 is provided with two fixing posts 827 and two combination posts 828, to pass through the mating through holes of the outer mounting disk 821 to fix the lock body 810, and to combine the inner mounting disk 831 and the inner cover plate 832, so that the outer cover plate 822 and the adjusting ring 825 are locked simultaneously, and cannot be rotated. Thus, when the user wishes to move the adjusting ring 825 to adjust the relative axial position between the lock bolt and the lock bolt hole of the door plate, he needs to detach all of the parts outside of the outer rotation shaft 811, thereby causing inconvenience in assembly, and thereby easily wearing the cylindrical type lock during detachment.

### SUMMARY OF THE INVENTION

The primary objective of the present invention is to provide a lock bolt alignment adjusting structure of a cylindrical type lock, wherein the adjusting ring is mounted individually, so that the user only needs to detach a few simple parts of cylindrical type lock located adjacent to the inner side of the door plate, so as to directly rotate the adjusting ring, thereby conveniently and quickly adjusting a relative axial position between the adjusting ring and the lock bolt, so as to align with the axial position of a lock bolt hole of a door plate.

In accordance with the present invention, there is provided a lock bolt alignment adjusting structure of a cylindrical type lock includes a lock body, an outer rotation shaft, an inner rotation shaft, a driven member, and an adjusting ring. The lock body has two ends for passage and insertion of the outer rotation shaft and the inner rotation shaft, to drive the driven member mounted in the lock body. The driven member is externally connected with a lock bolt. The adjusting ring is mounted individually, and has an inner thread, a flange, and multiple teeth. The inner thread is screwed on the outer thread of a tube extended from the lock body. Thus, the teeth of the flange may be rotated to adjust a relative axial position between the adjusting ring and the lock bolt, so as to align with a lock bolt hole of a door plate.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a first conventional cylindrical type lock in accordance with the prior art;

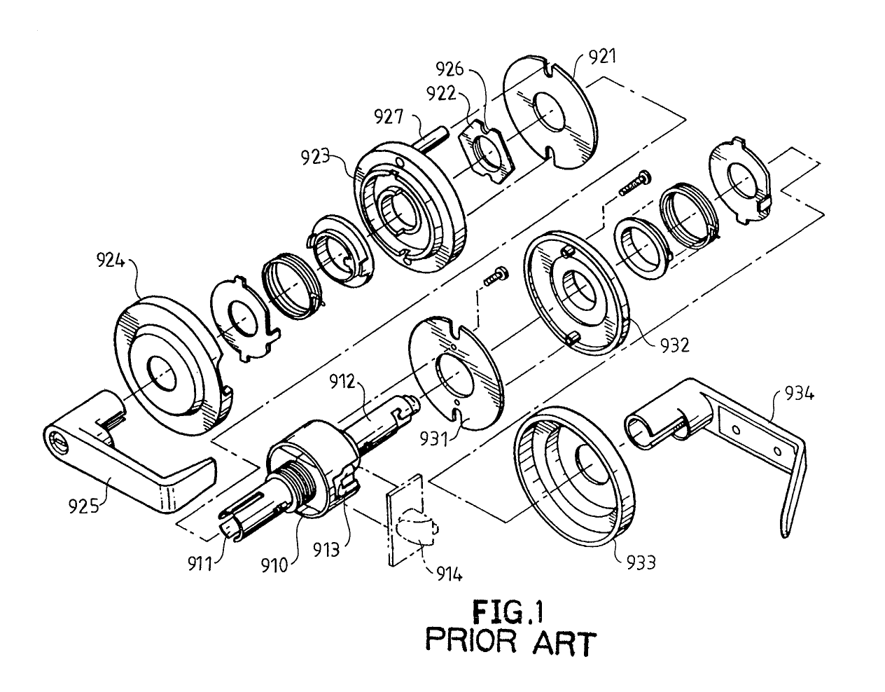

FIG. 2 is an exploded perspective view of a second conventional cylindrical type lock in accordance with the prior art;

FIG. 3 is an exploded perspective view of a lock bolt alignment adjusting structure of a cylindrical type lock in accordance with a preferred embodiment of the present invention;

FIG. 4 is a plan cross-sectional assembly view of the lock bolt alignment adjusting structure of a cylindrical type lock mounted on a thicker door plate in accordance with a preferred embodiment of the present invention;

FIG. 5 is a cross-sectional view of the lock bolt alignment adjusting structure of a cylindrical type lock taken along line 5-5 as shown in FIG. 4;

FIG. 6 is a plan cross-sectional assembly view of the lock bolt alignment adjusting structure of a cylindrical type lock mounted on a thinner door plate in accordance with a preferred embodiment of the present invention.

### DETAILED DESCRIPTION OF THE PREFERRED EMBODIMENTS

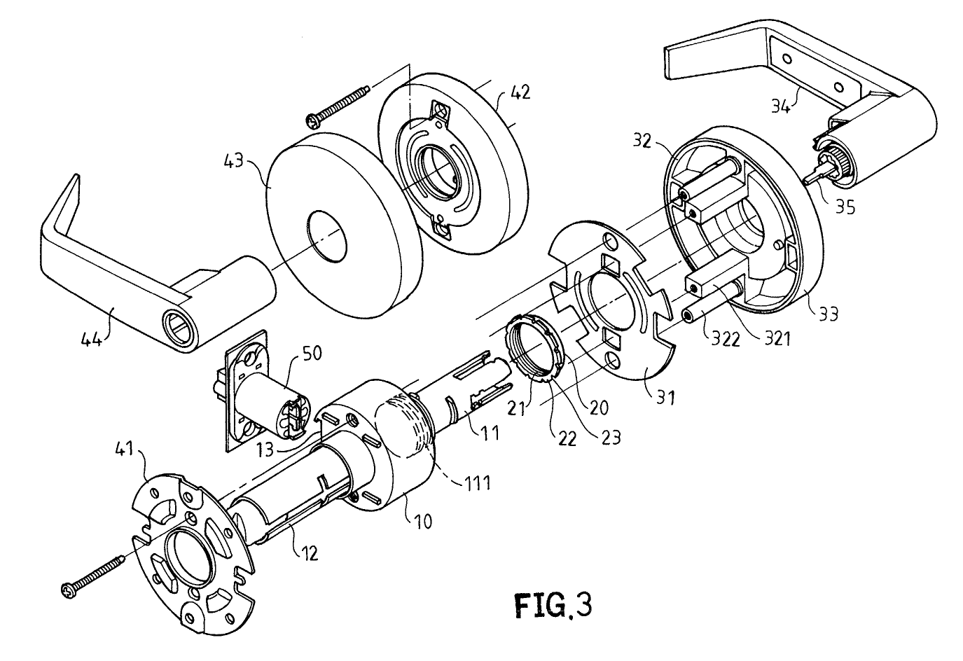

Referring to the drawings and initially to FIGS. 3-6, a lock bolt alignment adjusting structure of a cylindrical type lock in accordance with a preferred embodiment of the present invention is shown.

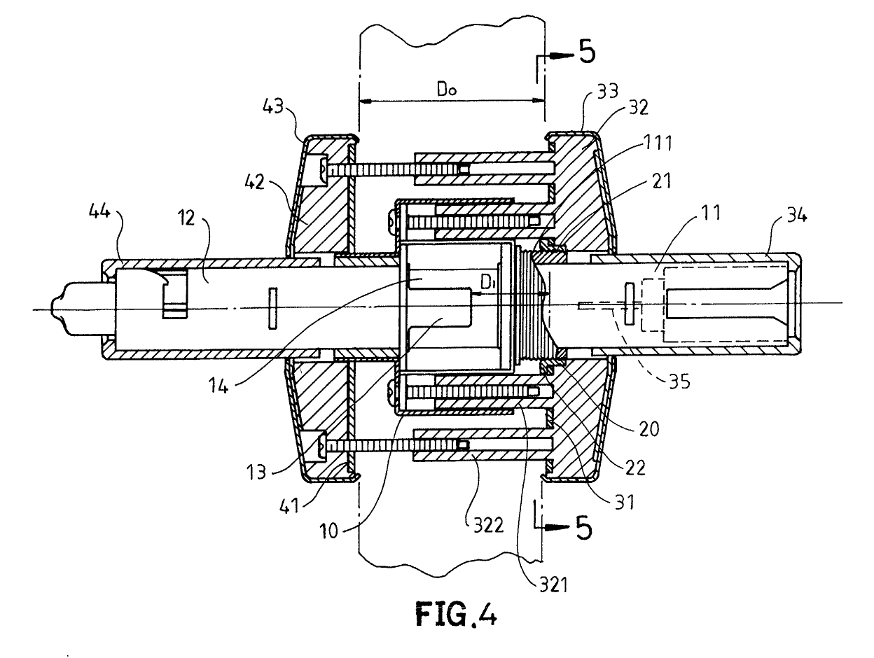

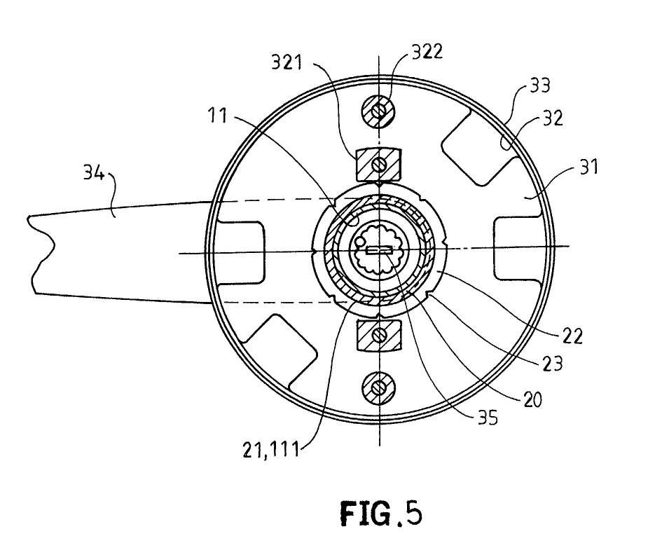

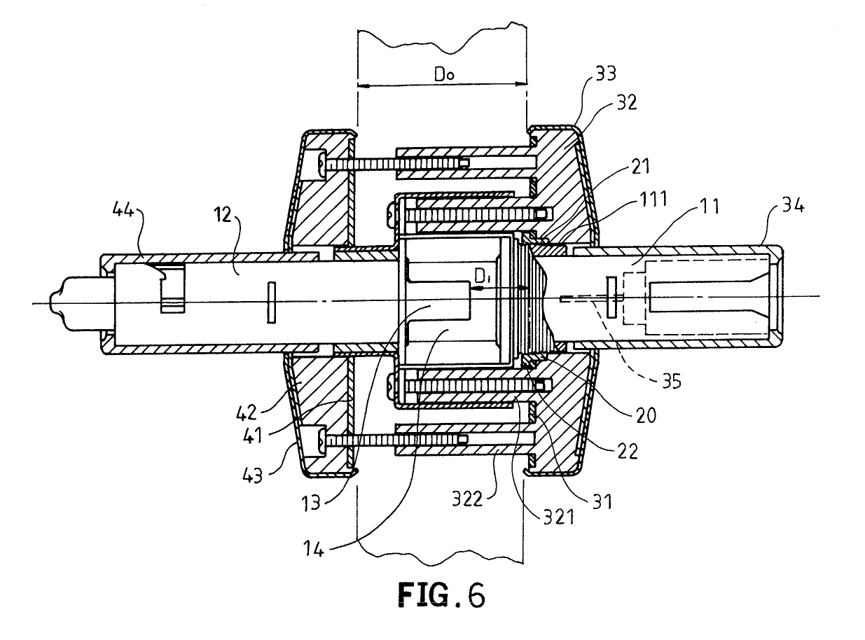

FIG. 3 is an exploded perspective view of a lock bolt alignment adjusting structure of a cylindrical type lock in accordance with a preferred embodiment of the present invention. FIG. 4 is a plan cross-sectional assembly view of the lock bolt alignment adjusting structure of a cylindrical type lock mounted on a thicker door plate in accordance with a preferred embodiment of the present invention. FIG. 5 is a cross-sectional view of the lock bolt alignment adjusting structure of a cylindrical type lock taken along line 5-5 as shown in FIG. 4. FIG. 6 is a plan cross-sectional assembly view of the lock bolt alignment adjusting structure of a cylindrical type lock mounted on a thinner door plate in accordance with a preferred embodiment of the present invention.

Referring to FIGS. 3-5, the lock bolt alignment adjusting structure of a cylindrical type lock in accordance with a preferred embodiment of the present invention comprises a lock body 10, an outer rotation shaft 11, an inner rotation shaft 12, a driven member 14, an adjusting ring 20, an outer mounting disk 31, an outer cover plate 32, an inner mounting disk 41, and an inner cover plate 42.

The lock body 10 has a cylindrical shape, and has two ends for passage and insertion of the outer rotation shaft 11 and the inner rotation shaft 12 to connect the driven member 14. The driven member 14 is protruded outward from am elongated slot 13 of the lock body 10, and has a locking port for hooking a lock bolt 50. Thus, rotation of the outer rotation shaft 11 and the inner rotation shaft 12 may drive the driven member 14 and the lock bolt 50 to retract inward or to return to the original position.

The adjusting ring 20 is mounted individually, and has an inner thread 21, a flange 22, and multiple teeth 23. The inner thread 21 is screwed on an outer thread 111 of a tube of an outer side of the lock body 10. Thus, a rod-shaped tool (not shown), such as a screwdriver or the like, may be used to rotate the flange 22 and the teeth 23 to directly adjust the distance between the adjusting ring 20 and the lock body 10, so that the driven member 14 and the lock bolt 50 that are moved in concert with the outer rotation shaft 11 may align with a relative axial position of the lock bolt hole (not shown) of a door plate.

When the lock bolt alignment adjusting structure of a cylindrical type lock in accordance with a preferred embodiment of the present invention is assembled, the user only needs to detach the inner handle 44, the inner decorative plate 43, the inner cover plate 42, and the inner mounting disk 41, without having to detach the parts at the outer side, such as the outer handle 34, the lock core 35, the outer decorative plate 33, and the outer cover plate 32. After adjustment of the adjusting ring 20 is accomplished and the lock bolt 50 is combined, the outer cover plate 32 has two fixing posts 321 and two combination posts 322 that are axially extended inward and are combined with the inner mounting disk 41 and the inner cover plate 42. At the same time, the flange 22 of the adjusting ring 20 is properly locked in an inner side of a central hole formed in the outer mounting disk 31, thereby preventing the lock body 10 from being loosened and displaced. Finally, the inner decorative plate 43 and the inner handle 44 may be mounted on the inner side of the door plate, thereby entirely assembling the cylindrical type lock.

Referring to FIGS. 4 and 6, the lock bolt alignment adjusting structure of a cylindrical type lock in accordance with a preferred embodiment of the present invention may be mounted on a thicker door plate or a thinner door plate.

The cylindrical type lock of the present invention is often disposed at a semi-assembled state when being sold. That is, the outer side complicated parts that are not easily assembled and dismantled have been assembled in advance except the inner mounting disk 41, the inner cover plate 42, the inner decorative plate 43, and the inner handle 44. Thus, the user only needs to use a rod-shaped tool (not shown), such as a screwdriver or the like, to rotate the concave portions between the teeth 23 of the flange 22 of the adjusting ring 20, thereby rotating and adjusting the adjusting ring 20, so that the distance between the lock body 10 and the lock bolt hole (not shown) of a door plate may be changed, and the axial position of the lock bolt 50 may exactly align with the axial position of the lock bolt hole of the door plate.

As shown in FIG. 4, when mounting a thicker door plate having a thickness D₀, the adjusting ring 20 may be adjusted, so that the lock body 10, the outer rotation shaft 11, the driven member 14 and the lock bolt 50 may be moved axially. After adjustment, the axial distance between the lock bolt 50 and the outer side of the door plate is equal to the axial distance D₁ between the lock bolt hole of the door plate and the outer side of the door plate.

As shown in FIG. 6, when mounting a thinner door plate having a thickness D₀′, the adjusting ring 20 may be adjusted, so that the lock body 10, the outer rotation shaft 11, the driven member 14 and the lock bolt 50 may be moved axially. After adjustment, the axial distance between the lock bolt 50 and the outer side of the door plate is equal to the axial distance D₁′ between the lock bolt hole of the door plate and the outer side of the door plate.

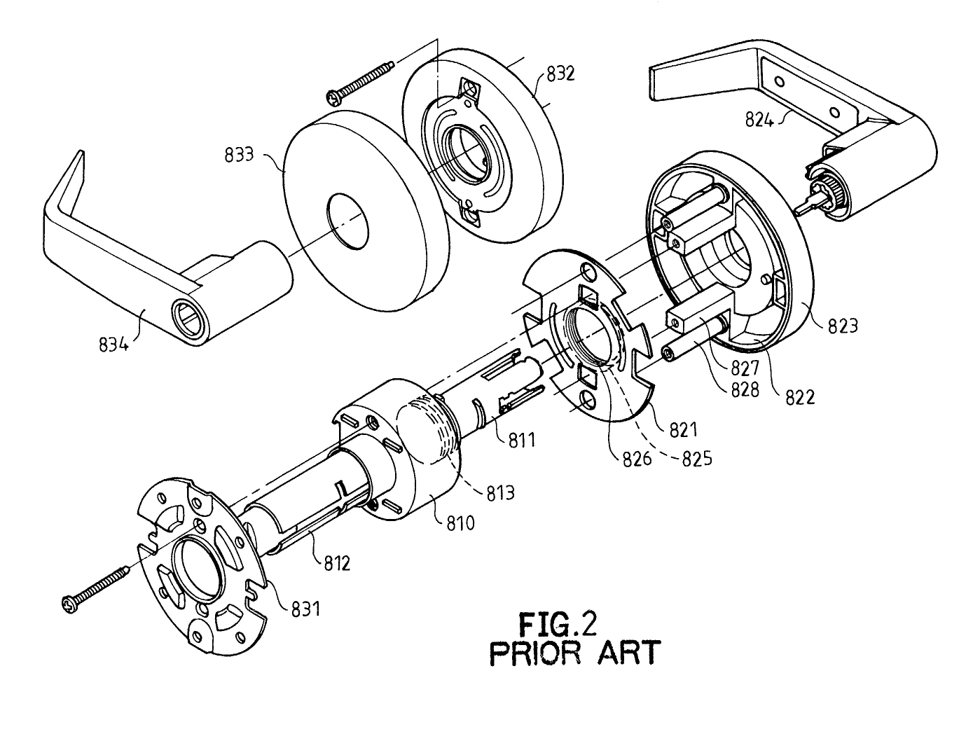

Referring to FIGS. 2 and 3, the lock bolt alignment adjusting structure of a cylindrical type lock in accordance with a preferred embodiment of the present invention is primarily provided with and adjusting ring 20. Especially, the adjusting ring 20 is mounted individually, and includes an inner thread 21, a flange 22, and multiple teeth 23. The inner thread 21 is screwed on an outer thread 111 of a tube of an outer side of the lock body 10. Thus, the relative axial position between the adjusting ring 20 and the lock bolt 50 may be adjusted by the teeth 23 of the flange 22, so as to align with the lock bolt hole of a door plate. In comparison with the conventional lock bolt alignment adjusting structure of a cylindrical type lock in accordance with the prior art, the lock bolt alignment adjusting structure of a cylindrical type lock in accordance with the present invention may quickly adjust the relative axial position between the adjusting ring and the lock bolt, without having to detach the outer side complicated parts that are not easily assembled and dismantled, thereby simplifying the assembling process of the cylindrical type lock.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A lock bolt alignment adjusting structure of a cylindrical type lock, comprising:
a lock body, having two ends for passage and insertion of an outer rotation shaft and an inner rotation shaft, a tube extended from an outer side of the lock body and formed with an outer thread, the lock body provided with an elongated slot;
a driven member, mounted in the lock body, and moved in concert with the outer rotation shaft and the inner rotation shaft, the driven member having a locking port protruded outward from the elongated slot of the lock body for hooking a lock bolt;
an outer mounting disk, provided with a central hole; and
an adjusting ring, having an inner thread, a flange, and multiple teeth, the inner thread screwed on the outer thread of the tube of the lock body, the flange locked in the outer mounting disk, wherein the teeth of the flange may be rotated to adjust a relative axial position between the adjusting ring and the lock bolt, so as to align with a lock bolt hole of a door plate.

2. The lock bolt alignment adjusting structure of a cylindrical type lock as claimed in claim 1, further comprising an outer cover plate provided with two fixing posts and two combination posts.

3. The lock bolt alignment adjusting structure of a cylindrical type lock as claimed in claim 2, wherein the lock body is provided with two combination holes to mate with the two fixing posts of the outer cover plate.

4. The lock bolt alignment adjusting structure of a cylindrical type lock as claimed in claim 2, further comprising an inner mounting disk provided with two through holes to mate with the two combination posts of the outer cover plate.

5. The lock bolt alignment adjusting structure of a cylindrical type lock as claimed in claim 2, further comprising an inner cover plate provided with two combination holes to mate with the two combination posts of the outer cover plate.
